(19) United States
(12) Patent Application Publication
(10) Pub. No.: US 2023/0399261 A1
(43) Pub. Date: Dec. 14, 2023

(54) POLYPROPYLENE FIBER FOR FIBER CEMENT-REINFORCED COMPOSITES

(71) Applicants: Braskem S.A., Camaçari (BR); UNIVERSIDADE DE SÃO PAULO, São Paulo City (BR)

(72) Inventors: Mauro Alfredo Soto Oviedo, São Paulo (BR); Holmer Savastano Junior, São Paulo City (BR); Ronaldo Soares Teixeira, São Paulo City (BR)

(73) Assignees: Braskem S.A., Camaçari (BR); UNIVERSIDADE DE SÃO PAULO, São Paulo City (BR)

(21) Appl. No.: 18/332,419

(22) Filed: Jun. 9, 2023

Related U.S. Application Data
(60) Provisional application No. 63/371,913, filed on Aug. 19, 2022.
(60) Provisional application No. 63/351,109, filed on Jun. 10, 2022.

(51) Int. Cl. C04B 16/06; C04B 28/04; D01F 6/06; D01F 1/10

(52) U.S. Cl. CPC C04B 16/0633; C04B 28/04; D01F 6/06; D01F 1/10; C04B 2111/00594

(57) ABSTRACT

A polypropylene fiber including: a polypropylene matrix, at least a surface modifier, and at least an additive selected from surfactants, lubricating agents or mixtures thereof. A method of producing polypropylene fibers by (i) mixing a polypropylene with a surface modifier in extrusion, (ii) melt spinning the composition obtained in step (i) to produce the fibers, where a surfactant is added to step (i) and/or a lubricant is applied to the fibers during step (ii). A fiber cement-reinforced composite including a cementitious matrix, a cellulosic component, optionally, a limestone component and a polypropylene fiber comprising: a polypropylene matrix, at least a surface modifier, at least one additive selected from surfactants, lubricating agents and mixtures thereof. An article comprising the fiber cement-reinforced composite and a roof tile comprising the fiber cement-reinforced composite.

### CROSS-REFERENCE TO RELATED APPLICATIONS

This application claims priority to U.S. provisional application No. 63/351,109 filed on Jun. 10, 2022 and U.S. provisional application No. 63/371,193 filed on Aug. 19, 2022 the entire contents of which are hereby incorporated by reference.

### BACKGROUND

The use of composite materials in construction, such as concrete and mortar reinforced with fibers has grown considerably in recent years. Fiber-cement products had been widely used in the world due to their versatility as corrugated and flat roofing materials, cladding panels and water containers presented in a significative number of building and agriculture applications. The primary reason for incorporating fibers into the cement matrix is to improve the toughness, tensile strength and the cracking deformation characteristics of the resultant composite

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a polypropylene fiber that includes a polypropylene matrix, at least a surface modifier, and at least an additive selected from surfactants, lubricating agents, or mixtures thereof.

In another aspect, embodiments disclosed herein relate to a methods of producing polypropylene fibers that includes the steps of (i) mixing a polypropylene with a surface modifier in extrusion and (ii) melt spinning the composition obtained from step (i) to produce the polypropylene fibers, wherein a surfactant is added to step (i) and/or a lubricant is applied to the fibers during step (ii).

In another aspect, embodiments disclosed herein relate to cement-reinforced composites comprising a cementious matrix; a polypropylene fiber that includes a polypropylene matrix, at least a surface modifier, and at least an additive selected from surfactants, lubricating agents, or mixtures thereof; a cellulosic component; and optionally a limestone component.

In yet another aspect, embodiments disclosed herein relate to an article that includes cement-reinforced composites comprising a cementious matrix; a polypropylene fiber that includes a polypropylene matrix, at least a surface modifier, and at least an additive selected from surfactants, lubricating agents, or mixtures thereof; a cellulosic component; and optionally a limestone component.

In yet another aspect, embodiments disclosed herein relate to a roof tile that includes cement-reinforced composites comprising a cementious matrix; a polypropylene fiber that includes a polypropylene matrix, at least a surface modifier, and at least an additive selected from surfactants, lubricating agents, or mixtures thereof; a cellulosic component; and optionally a limestone component.

Other aspects and advantages of the claimed subject matter will be apparent from the following description and the appended claims.

### BRIEF DESCRIPTION OF DRAWINGS

FIG. 1A shows modulus of rupture (MOR) of cementitious composites produced by suction and pressing process cured at 10 days (10d) and after accelerated aging (100 C).

FIG. 1B shows modulus of rupture (MOR) of cementitious composites produced by Hatschek process cured at 10 days (10d) and after accelerated aging (100 C).

FIG. 1C shows limit of proportionality (LOP) of cementitious composites produced by suction and pressing process cured at 10 days (10d) and after accelerated aging (100 C).

FIG. 1D shows limit of proportionality (LOP) of cementitious composites produced by Hatschek process cured at 10 days (10d) and after accelerated aging (100 C).

FIG. 1E shows modulus of elasticity (MOE) of cementitious composites produced by suction and pressing process cured at 10 days (10d) and after accelerated aging (100 C).

FIG. 1F shows modulus of elasticity (MOE) of cementitious composites produced by Hatschek process cured at 10 days (10d) and after accelerated aging (100 C).

FIG. 1G shows specific energy (SE) of cementitious composites produced by suction and pressing process cured at 10 days (10d) and after accelerated aging (100 C).

FIG. 1H shows specific energy (SE) of cementitious composites produced by Hatschek process cured at 10 days (10d) and after accelerated aging (100 C).

FIG. 2A shows Image Scanning electron microscopy (SEM-BSE) of polished surfaces of composites reinformed with K1 fibers.

FIG. 2B shows Image Scanning electron microscopy (SEM-BSE) of polished surfaces of composites reinformed with PP COMM fibers.

FIG. 3A shows an SEM micrograph of the composite reinforced with K1 fibers after accelerated aging at 100 cycles (100 C).

FIG. 3B shows an SEM micrograph of the composite reinforced with PVA fibers after accelerated aging at 100 cycles (100 C).

FIG. 4A shows water absorption (WA) of cementitious composites produced by suction and pressing process cured at 10 days (10d) and after accelerated aging (100 C).

FIG. 4B shows water absorption (WA) of cementitious composites produced by Hatschek process cured at 10 days (10d) and after accelerated aging (100 C).

FIG. 4C shows bulk density (BD) of cementitious composites produced by suction and pressing process cured at 10 days (10d) and after accelerated aging (100 C).

FIG. 4D shows bulk density (BD) of cementitious composites produced by Hatschek process cured at 10 days (10d) and after accelerated aging (100 C).

FIG. 4E shows apparent porosity (AP) of cementitious composites produced by suction and pressing process cured at 10 days (10d) and after accelerated aging (100 C).

FIG. 4F shows apparent porosity (AP) of cementitious composites produced by Hatschek process cured at 10 days (10d) and after accelerated aging (100 C).

### DETAILED DESCRIPTION

The present disclosure is related to polypropylene fiber and fiber cement-reinforced composites containing the same. The cement-reinforced composites of the present disclosure are particularly indicated for applications that require good mechanical properties, including building elements such as roof tiles. The polypropylene fibers in the present disclosure exhibit improved performance as a reinforcing element in order to guarantee a ductile performance of cement articles.

In one aspect, embodiments disclosed herein relate to polypropylene fibers comprising: a polypropylene matrix, at least a surface modifier, and at least an additive selected from surfactants, lubricating agents or mixtures thereof.

The term “polypropylene” as used herein refers to propylene homopolymers, propylene random copolymers, heterophasic propylene copolymers and mixtures thereof.

In one or more embodiments, the polypropylene comprises at least a comonomer selected from ethylene and C4 to C8 alpha olefins, where the comonomer percentage by weight (wt. %) ranges from a lower limit selected from 0.5, 1, or 5 wt. %, to an upper limit selected from 2.5, 5, or 10 wt. %, based on the weight of polypropylene, where any lower limit may be combined with any upper limit.

In one or more embodiments, the polypropylene is a heterophasic polypropylene including a rubber phase dispersed in a polypropylene continuous phase, where the rubber phase includes propylene and at least a comonomer selected from ethylene, C4 to C8 alpha-olefins, where the comonomer is present at a percent by weight (wt. %) of the rubber phase that ranges from a lower limit selected from any of 5, 10, 15, and 20 wt. %, to an upper limit selected from any of 50, 60, 70, and 75 wt. %, where any lower limit may be paired with any upper limit. The rubber phase may be present at a percent by weight (wt. %) that ranges from a lower limit selected from any of 2, 3, 5, and 10 wt. %, to an upper limit selected from any of 50, 60, 70, and 75 wt. %, based on the heterophasic polypropylene weight, where any lower limit may be paired with any upper limit. In a particular embodiment, the polypropylene is a homopolymer.

In one or more embodiments, the polypropylene has a Melt Flow Rate (230° C./2.16 kg), as determined according to ASTM D1238, that ranges from a lower limit selected from 10 g/10 min, 14 g/10 min or 16 g/10 min to an upper limit selected from 40 g/10 min, 26 g/10 min, or 20 g/10 min, where any lower limit may be combined with any upper limit.

In one or more embodiments, the polypropylene is a homopolymer having a Melt Flow Rate (230° C./2.16 kg), as determined according to ASTM D1238, that ranges from 10 to 30 g/10 min. An example of polypropylene used is the PP H216 provided by Braskem.

The term “surface modifier” as used herein refers to organic or inorganic fillers and mixtures thereof. The “surface modifier” can promote physical adhesion of the composite cement to the fiber surface. In one embodiment, the surface modifier is inorganic, and it is selected from the group that comprises talc, calcium carbonate, calcium hydroxide, mica, calcium silicate, clay, kaolin, alumina, silica, wollastonite, magnesium carbonate, magnesium hydroxide, zinc oxide, titanium oxide, barium sulfate, zinc sulfate and combinations thereof.

In one particular embodiment, the surface modifier is calcium carbonate. The surface modifier particle is optionally coated, or it presents a surface treatment in order to improve its hydrophobicity and/or compatibility with the polypropylene matrix. In a particular embodiment, the surface modifier is a coated calcium carbonate. In one embodiment, the surface modifier is used in the form of a masterbatch. One example of coated calcium carbonate suitable for the present disclosure is FiberLink 201S provided by Immerys™.

In one embodiment, the surface modifier is present in a percentage by weight (wt. %) that ranges from a lower limit selected from 0.3 wt. %, 0.5 wt. %, 0.7 wt. %, 1.0 wt. % and an upper limit selected from 20 wt. %, 15 wt. %, 10 wt. %, 5 wt. %, based on the polypropylene fiber weight, where any lower limit may be combined with any upper limit.

The surface modifiers may be incorporated in the polypropylene matrix by extrusion.

In one or more embodiments, the surface modifier is FiberLink 201S calcium carbonate and it is present in a percentage by weight (wt. %) that ranges from 0.5 to 10.0 wt. % based on the polypropylene fiber weight.

The term “surfactant” as used herein refers to ionic, non-ionic and amphoteric surfactants or combinations thereof. In one embodiment, the surfactants may be selected from sulfates, sulfonates, phosphate esters, carboxylates, amines, quaternary ammonium, alcohols, acids, ethoxylates, and combinations thereof. The surfactant may have a carbon chain comprising from 8 to 13 carbon atoms. In another embodiment, the surfactant is a fatty alcohol including ethylene oxide and/or propylene oxide, allowing a controlled adhesion to the cementitious matrix.

Examples of surfactants suitable for the present disclosure are Alkomol L306 provided by Oxiteno™, ethoxylated fatty acid ester, and ethoxylated alcohol phosphate. When present, the amount of surfactant in the fiber ranges from a lower limit selected from 0.3 wt. %, 0.4 wt. % or 0.5 wt. % to an upper limit selected from 7 wt. %, 5 wt. % or 3 wt. %, based on the polypropylene fiber weight, where any lower limit may be combined with any upper limit. The surfactants may be incorporated in the polypropylene matrix by extrusion. In one or more embodiments, the amount of surfactant in the fiber ranges from a lower limit selected from 0.5 to 5.0 wt. %.

The lubricating agent, also known as “finishing oil”, “spin finish” or “finish”, may be used during polypropylene fiber production. Polyolefins resins tend to develop high electrostatic charges and excessive tension when running over guides, godets, and other machine components during processing and subsequent handling. Therefore, lubricating agents containing various compounds may be used on the surface of the polypropylene fiber during the spinning and drawing production stages. An example of lubricating agent suitable for the present disclosure is Marlube NC-90. The lubricating agent may be applied to the fibers during the spinning process when the fibers are produced.

In one or more embodiments, the polypropylene fiber presents a rheological polydispersity index, as determined according to ASTM D4440 (Plate Rheometry test), that ranges from a lower limit of 1.75, 2 or 2.25 to an upper limit of 4, 3.5 or 3, where any lower limit may be combined with any upper limit.

In one or more embodiments, the polypropylene fiber presents a Mw/Mn that ranges from a lower limit of 2, 2.5 or 3 to an upper limit of 5.5, 5 or 4.90, as determined according to GPC, where any lower limit may be combined with any upper limit.

In one or more embodiments, the polypropylene fiber presents a tenacity, as determined according to NBR13385 DE 05/1995, that ranges from a lower limit of 7, 8 or 9 cN/dtex to an upper limit of 15, 14, 13, 12, 11, 10.5 or 10 cN/dtex, where any lower limit may be combined with any upper limit.

In one or more embodiments, the polypropylene fiber presents an elongation, as determined according to NBR13385 DE 05/1995, that ranges from a lower limit of 5, 6 or 7% to an upper limit of 18, 16, 14 or 12%, where any lower limit may be combined with any upper limit.

The polypropylene fiber may be prepared using conventional extrusion processes to produce high tenacity monofilaments.

In another aspect, embodiments disclosed herein relate to a method of producing polypropylene fibers including the steps of: (i) mixing a polypropylene with at least one surface modifier in extrusion, (ii) melt spinning the composition obtained in step (i) to produce the fibers, wherein a surfactant is added in step (i) and/or a lubricant is applied to the fibers during step (ii).

In one embodiment, the fibers are prepared by a melt spinning process using a spinning pack. The spinning pack comprises three-parts filters, distributor (which distributes the molten polymer over to a die surface) and the die. In this way, spinning holes and cooling rates are used in the production of spinning melting heads to obtain filaments with high tenacity within narrow dispersion of properties. The spinning process may comprise two steps: spinning/bobbin and drawing. After that, the fibers may be cut in small filaments wherein the size will depend on the final application requirements. In one embodiment, the fibers are cut into filaments having from 5 to 20 mm length.

In another aspect, embodiments disclosed herein relate to a viable cementing material using cellulosic pulp and polypropylene as reinforcing components. In this regard, embodiments disclosed herein relate to fiber cement-reinforced composites formed by a cement matrix and a polypropylene fiber according to one or more embodiments, where the fiber cement-reinforced composite comprises: a cementitious matrix; a polypropylene fiber including: a polypropylene matrix, at least a surface modifier, and at least one additive selected from surfactants, lubricating agents and mixtures thereof; a cellulosic component; and optionally a limestone component.

The term “cement” as used herein refers to any conventional cement formulation including Portland cements. Further, the cement formulation may comprise sand, siliceous loams, pozzolans, diatomaceous earth (DE), iron pyrites, alumina, limestone, clay, carbon dioxide, calcium oxide, gypsum, and other suitable fillers and additives.

According to one embodiment, Ordinary Portland cement (OPC) type CP V-ARI, corresponding to ASTM C 150, Type III is used in the fiber cement-reinforced composites disclosed herein because of its finer particle size and higher reactivity. This type of cement contains higher levels of tricalcium silicate (C3S) and dicalcium silicate (C2S) for the formation of C—S—H.

The term “cellulosic component” as used herein refers to any cellulosic component. Examples include unbleached, unrefined eucalyptus (Eucalyptus grandis) Kraft pulp obtained from Suzano S/A, Brazil. Physical characteristics of the unbleached eucalyptus pulp are: 0.83 mm in length and 16.4 mm in width, fibrous material of 18.17 g and fines content by mass of 25.7%.

In one embodiment, the cementitious matrix is present in the fiber cement-reinforced composite in a percentage by weight (wt. %) that ranges from 40% to 80% wt.

In one embodiment, the polypropylene fibers are present in the fiber cement-reinforced composite in a percentage by weight (wt. %) that ranges from a lower limit selected from 0.3 wt. %, 0.5 wt. %, 0.7 wt % or 1.0 wt % and a upper limit selected from 5 wt. %, 4 wt. %, 3 wt. % or 2.5 wt. % based on the total weigh of the fiber cement-reinforced composite, where any lower limit may be paired with any upper limit.

The fiber length is an important characteristic to achieve the properties of the cement-reinforced composite of the present invention. In this regard, the fibers length used ranges from 7 to 14 mm. In one or more embodiments, the fiber length ranges from 8 and 12 mm.

In one embodiment, the cellulosic component is present in fiber cement-reinforced composite in a percentage by weight (wt. %) that ranges from a lower limit selected from 0.3 wt. %, 0.5 wt. %, 0.7 wt % or 1.0 wt % and a upper limit selected from 10 wt. %, 5 wt. %, 3 wt. % or 2.5 wt. % based on the total weigh of the fiber cement-reinforced composite, where any lower limit may be paired with any upper limit.

In one embodiment, the limestone is present in the fiber cement-reinforced composite in a percentage by weight (wt. %) that ranges from 15 to 40% wt.

The fiber cement-reinforced composite of the present disclosure exhibits improved mechanical properties Modulus of Rupture, Modulus of Elasticity and low Specific Energy, when compared with traditional cement reinforced with polypropylene fibers.

The fiber cement-reinforced composite of the present disclosure may be used in a variety of applications such as roof tiles, plane or corrugated boards for covering or building elements, e.g. wall boards.

The fiber cement-reinforced composite may be prepared by any method known in the art, including industrial and laboratorial methods. Examples of such methods for preparing cement-reinforced composites are described hereinafter, and are described in more detail in the literature.

Industrial Process (Hatschek)

The Hatschek process is the most widely employed one in producing fiber cement components. The Hatschek process consists of producing fiber cement sheets by stacking thin laminas made from a suspension (slurry) of cement, fibers, mineral admixtures and water, in a process that resembles the production of paper. The first step is to prepare a slurry, which consists of mixing an adequate proportion of solid materials, with water in a low solid concentration (10-15% of total mass). Cement, asbestos, cellulose fibers, limestone filler and water are the most commonly employed materials by the asbestos cement technology. The slurry is then transported to vats with sieve cylinders where wet solid material is deposited. Sequentially, running felt removes the material from the sieve cylinders, thus, forming a green lamina. Vacuum is applied to remove water from the lamina before it is transferred to the formation cylinder where the stacking is performed. Finally, the green sheet is cut, shaped (corrugated sheets and accessories), and submitted to curing.

Suction and Pressing Process

The suction and pressing process is a laboratory scale method that simulates the industrial method of fiber cement production, which is the Hatschek. The suction and pressing process was used to produce composites reinforced with cellulosic pulp. In this study, the formulations were established based on commercial raw materials used in the fiber cement industry.

### EXAMPLES

Polypropylene fibers were produced by mixing polypropylene with 80% FiberLink 201S calcium carbonate to get a masterbatch compound. The polypropylene was extruded with 1.0 to 4% of the masterbatch compound and 1.25% of Alkomol 306L, all together. (ii) melt spinning the composition obtained in step (i) to produce the fibers where, a surfactant is added in step (i) and/or a lubricant is applied to the fibers during step (ii).

A concrete example illustrating a method of producing polypropylene fibers is described hereinafter, which is not limiting.

Step 1 (Extrusion): the fiber was extruded at PTI 4″/30d extrusion machine from Neumag manufacturer at around 260° C., 90 bar Melt Pressure and 45 rpm rate. The Die has 6500 holes with 0.35 mm diameter and 1.75 length. The filaments obtained at 500 m/min speed spinning using 10% Pulcra Stantex 7292 spin finish had around 5.5 dtex titer.

Step 2 (Melt spinning): the Die used had 6500 holes with 0.35 mm diameter and 1.75 length. The filaments obtained at 500 m/min speed spinning using 10% Pulcra Stantex 7292 spin finish had around 5.5 dtex titer.

Step 3 (Drawing): the filaments was drawing at five stages heated rolls at around 80 m/min speed. The final titer was 1.1 dtex.

Step 4 (Staple): after taking 10% bath of Pulcra spin finish, the filaments were staple at around 9.8 mm length at 80 m/min cuter speed.

Three types of polypropylene (PP) fibers were used in the tests (K1, K2, and B6). Fibers K1 and K2 are according to the present invention, while fiber B6 was used for comparison. The formulations and some mechanical and physical properties of the fibers are presented in Tables 1 and 2, respectively.

TABLE 1
Formulation of the fibers tested (comparative
example vs. fibers of the present invention).

| | K1 | K2 | B6 |
|---|---|---|---|
| Polypropylene | PP homopolymer | PP | PP |
| matrix | (PP | homopolymer | homopolymer |
| | H216, | (PP | (PP |
| | Braskem) | H216, | H216, |
| | | Braskem) | Braskem) |
| MFR of the | 16 g/10 | 16 g/10 | 18 g/10 |
| PP matrix* | min | min | min |
| Amount of the PP | 97.75% | 95.55% | 100% |
| matrix (wt %) | | | |
| Surface | FiberLink | FiberLink | N/A |
| modifier | 201S | 201S | |
| Amount of the | 1.0% | 3.2% | N/A |
| surface modifier | | | |
| Surfactant and/ | Alkomol | Alkomol | N/A |
| or lubricant | 306L | 306L | |
| Amount of | 1.25% | 1.25% | N/A |
| the surfactant | | | |
| and/or lubricant | | | |

*according to ASTM D1238.

TABLE 2
Mechanical and Physical properties of the polypropylene fibers
(comparative example vs. fibers of the present invention).

| Properties | K1 | K2 | B6 |
|---|---|---|---|
| Ultimate tensile strength (MPa) | N/A | N/A | N/A |
| (NBR13385 DE May 1995) | | | |
| Young's modulus (GPa) | N/A | N/A | N/A |
| (NBR13385 DE May 1995) | | | |
| Titer (dtex) | 1.2 | 1.1 | 1.1 |
| (NBR13214 de October 1994) | | | |
| Length (mm) | 9.8 | 9.8 | 9.8 |
| Tenacity (cN/ctex) | 9.57 | 8.89 | 10.21 |
| (NBR13385 DE May 1995) | | | |
| Average thickness (μm) | 10 | 10 | 10 |
| Density (g/cm³) | 0.94 | 0.96 | 0.93 |
| Aspect Ratio | ~90 | ~90 | ~90 |

By the Hatschek and “Suction and pressing process” previously discussed, fibers K1, K2 and B6 were used to prepare fiber cement-reinforced composites. The flat pads were cured by an industrial process and were evaluated after 10 days (10d) and after 100 cycles (100 C). Ordinary Portland cement (OPC) type CP V-ARI, corresponding to ASTM C 150, Type III was selected because of its finer particle size and higher reactivity. Furthermore, limestone was used in the formulation as well. This type of cement contains higher levels of tricalcium silicate (C3S) and dicalcium silicate (C2S) for the formation of C—S—H.

The cement and limestone particles distributions were evaluated by a laser particle size analyzer (Malvern Mastersizer S long bed, version 2.19). Cement and limestone particles showed 50% of its mass less than 10.09 and 12.96 μm, respectively. Both raw materials exhibit similar particle distributions.

The quantitative chemical analysis was performed using PANalytical Axios Advanced X-ray fluorescence equipment. The main oxide compositions of cement and limestone are: SiO₂: 14.70, 9.40; CaO 67.20, 39.10; Al₂O₃4.07, 2.16; Fe₂O₃ 3.50, 1.25; MgO 3.13 and 8.90, respectively. The specific surface area (determined using the BET method) and specific density of raw materials were measured. The similar values of the specific surface area may be important to avoid competition of water between the raw materials in the system. OPC showed specific density 3.10 g/cm³ and 1.10 m²/g of area and limestone 2.80 g/cm³ of 1.14 m²/g of area.

One concrete example of the compositions of the fiber cement-reinforced composites is:
3.5% wt. % of cellulose kraft pulp (unbleached unrefined eucalyptus (Eucalyptus grandis). Kraft pulp was provided by Suzano S/A, Brazil;
65% wt. of ordinary Portland cement (OPC) type CP V-ARI;
30% wt. of limestone; and
1.5% wt. of the fiber according to the present invention (and comparative versions, as explained hereinafter).

For testing purposes, in addition to the fibers K1, K2 and B6, Polypropylene (PP) from Saint-Gobain Industry (PP COM) and polyvinyl alcohol (PVA) fiber from Kuraray S. A used in the cement industry were also used as a comparison. Both PP COM and PVA are commercially available.

Fibers K1, K2, B6, PP COM and PVA were used individually to form different types of fiber cement-reinforced composites. Each fiber was tested for mechanical properties, as discussed hereinafter.

The suction and pressing process in the laboratory was performed according to the following procedure: initially, the commercial bleached hardwood kraft pulp of eucalyptus was dispersed in water at 3000 rpm for 5 min. The ordinary Portland cement CP V-ARI and limestone were added, and the mixture was stirred at 1000 rpm for 5 min. The mixture was transferred in a casting box with negative pressure (80 kPa) applied to remove the excess water in the process. After this step, the fiber-cement composites were pressed at 3.2 MPa for 5 min. The fiber-cement composites were cured in sealed plastic bags at 29±2° C. for 2 days. Then, the plates were placed in a thermal bath at 60° C. for 5 days. The plates were then placed on the bench for 2 days and then immersed for 24 hours in water. The entire process totaled 10 days before testing.

Mechanical Characterization of the Composites

Mechanical tests were performed in a Machine EMIC, model DL 30000 equipped with a 1 kN load cell. A four-point bending configuration was employed in the determination of modulus of rupture (MOR), limit of proportionality (LOP), modulus of elasticity (MOE) and specific energy (SE) values. 75 mm span and 5 mm/min deflection rate were adopted in bending test. Equations. 1, 2 and 3 define MOR, LOP and MOE respectively:

$$MOR = \frac{P \cdot {L}_{v}}{b . {h}^{2}} \qquad Equation ( 1 )$$

$$LOP = \frac{{P}_{1} \cdot Lv}{b \cdot {h}^{2}} \qquad Equation ( 2 )$$

$$MOE = \frac{276 \cdot {L}_{v}^{3}}{1296 \cdot b \cdot {h}^{3}} \cdot ( \frac{P}{δ} ) \qquad Equation ( 3 )$$

where P is the maximum load, PLOP is the load at the upper point of the linear portion of the load deformation curve, Lv is the major span between the supports, b and h are the specimen width and depth respectively, and δ is the vertical displacement of the specimen.

$$Specific energy = \frac{absorbed energy}{b . h} \qquad Equation ( 4 )$$

Specific energy as shown in Equation 4 is defined as energy absorbed during bending test divided by specimen cross-sectional area. Absorbed energy was obtained by integration of the area below the load deflection curve to the point corresponding to a reduction in load carrying capacity to 90% of the maximum reached.

Physical Characterization Tests

Water absorption (WA), apparent porosity (AP), and bulk density (DA) values were obtained from the average of ten specimens for each mix design, following procedures specified by ASTM C 948-81 Standards.

Soak/Dry Accelerated Ageing Cycles

The soak/dry accelerated ageing test involved comparative analysis of physical and mechanical composites' performance, before and after soak/dry cycles. Specimens were successively immersed in water at 20±5° C. for 170 min, followed by an interval of 10 min, and then exposed to temperature of 70±5° C. for 170 min in a ventilated oven and with the final interval of 10 min. This procedure was based on recommendations of the EN 494 Standards. Each soak/dry set represents one cycle and was performed for 100 cycles and was obtained from the average of ten specimens for each mix design.

Scanning Electron Microscopy

Scanning electron microscopy (SEM) was used with a secondary electron (SE) detector operated at 10.0 kV accelerating voltage for visualization of the surface fiber morphologies. Energy dispersive X-ray spectroscopy (EDS) analyses were also conducted. EDS evaluates the interaction of chemical elements used for treatment on fiber surface (Santos et al., 2015). These were performed on the same surface specimens to obtain semi-quantitative compositional information. Samples were carbon coated before being analyzed in a Zeiss LEO 440 microscope.

Statistical Analysis

The mechanical and physical test were conducted under a completely randomized design with four treatments (PP COM, K1, K2, B6 and PVA) and ten replications. The effects of MOR, LOP, MOE, SE, WA, DA and PA were compared via statistical contrast by student test at 5% of significance. The ACTION statistical program was used.

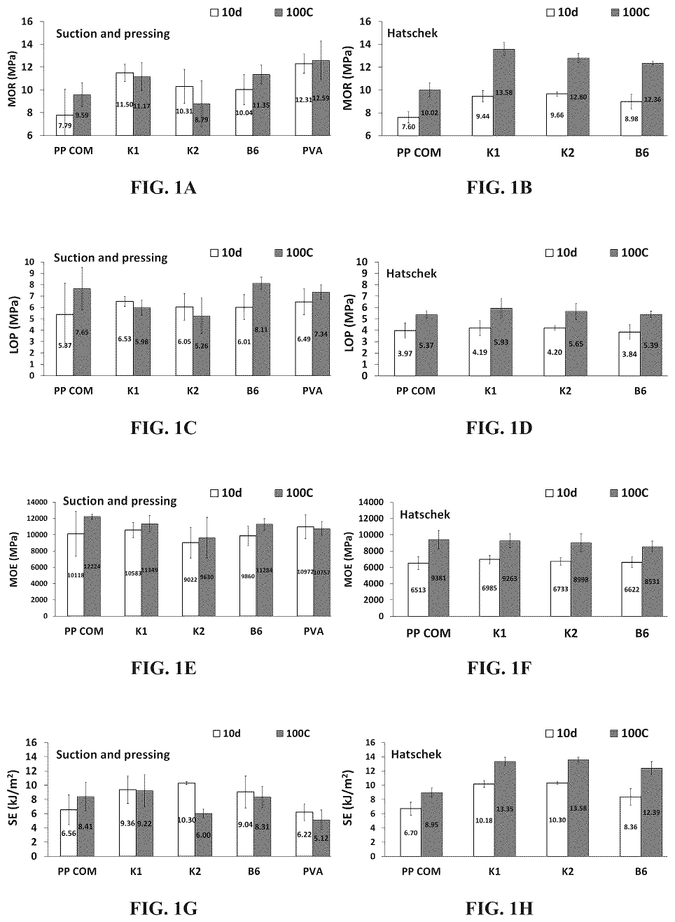

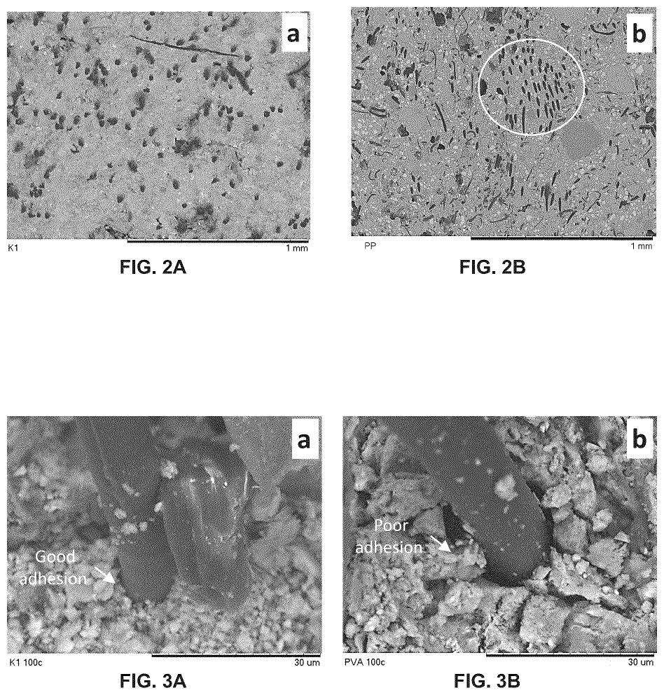

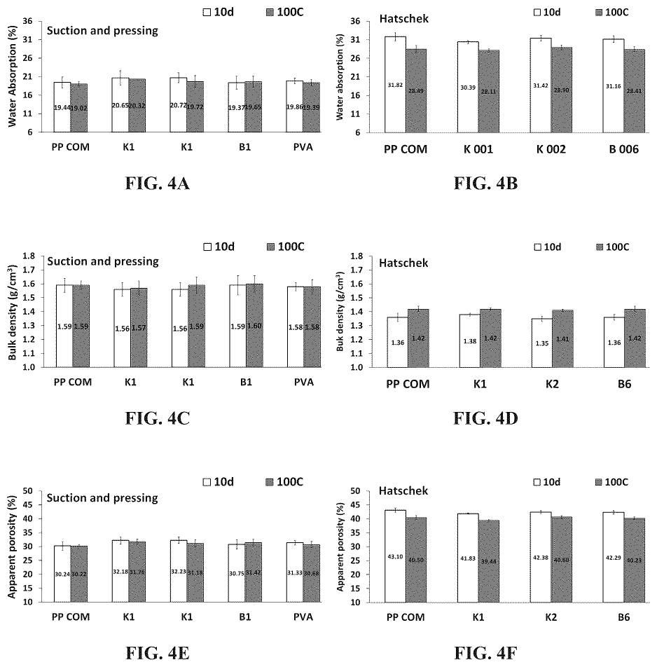

FIGS. 1 and 2 and Tables 3 and 4 show the mechanical properties (modulus of rupture (MOR), limit of proportionality (LOP), modulus of elasticity (MOE), and specific energy (SE)) of cementitious composites produced by suction and pressing and Hatschek process cured at 10 days (10d) and after accelerated aging (100 C), respectively. Tables 5 and 6 list the respective average values, standard deviations and statistical analyses of mechanical properties and physical characteristics, respectively.

The modulus of rupture (MOR) indicates the tensile strength in bending, as well as the interaction and strain distribution between fiber-matrix. The cementitious reinforced composites with K1, K2 and PVA fibers at 10 days of curing (10d) produced by suction and pressing and Hatschek showed the improved results in relation to the other fibers, respectively, according to the statistical analysis. These results may be linked to the physical characteristics (length and thickness) of the fibers, which improve the distribution of fibers within the composites. Another factor contributing to these values is the new technologies for processing and manufacturing PP fibers, which are undergoing innovations that increase their performance. Note that this contribution in the value of MOR was 47% for composites with new generation K1 fiber and 32% with K2 fibers in relation to the PP COM fiber produced by the suction and pressing process and Hatschek which are normally used commercially in the cement industries, respectively. FIG. 2 presents a SEM micrograph image between K1 and PP COM fibers, which shows an improvement in the interaction of the fibers with the cement, contributing to a better distribution of the tension between the fiber and the matrix.

After accelerated aging during 100 cycles (100 C), the K1 composite produced by both the suction and pressing process and Hatschek process increased the MOR values in relation to 10d, possibly due to the synergy between synthetic fibers and vegetable fiber (cellulose pulp) and the densification of the cement matrix after the continuous process of cement hydration that improves the fiber-matrix interface. Cellulosic pulps are hydrophilic and absorb water from the system through the continuous process of cement hydration. However, K1 fibers are hydrophobic and do not absorb water. Note that the K1 fibers also showed an increase of MOR in relation to the PVA fibers. In most cases, PVA fibers present better results than PP fibers in the literature.

Table 3.1—Average values and standard deviations of modulus rupture (MOR), Limit of proportionality (LOP), modulus of elasticity (MOE), specific energy (SE), water absorption (WA), bulk density (BD) and apparent porosity (AP) of the composite cementitious reinforced with polypropylene fiber (PP COM, K1, K2, B6) and polyvinyl alcohol fiber (PVA) produced by suction and pressing process in the conditions at 10 days (10d) of curing and after 100 accelerated aging cycles (100 C)*.

| | Suction and | MOR | LOP | MOE | SE |
|---|---|---|---|---|---|
| Formulations | pressing | (MPa) | (MPa) | (MPa) | (kJ/m²) |
| PP COM | 10 | 7.79 ± 2.29 c | 5.37 ± 2.79 a | 10118 ± 2778 a | 6.56 ± 2.11 b, c |
| K001 | days | 11.50 ± 0.78 a, b | 6.53 ± 0.44 a | 10583 ± 937 a | 9.36 ± 1.91 a |
| K002 | | 10.31 ± 1.50 b | 6.05 ± 1.18 a | 9022 ± 1877a | 10.30 ± 0.22 a |
| B006 | | 10.04 ± 1.33 b | 6.01 ± 1.10 a | 9860 ± 1191 a | 9.04 ± 2.25 a, b |
| PVA COM | | 12.31 ± 0.85 a | 6.49 ± 1.14 a | 10972 ± 148 a | 6.22 ± 1.18 c |
| PP COM | 100 | 9.59 ± 1.05 2 | 7.65 ± 1.88 1, 2 | 12224 ± 310 1 | 8.41 ± 2.04 1 |
| K001 | cycles | 11.17 ± 1.23 1 | 5.98 ± 0.67 2, 3 | 11349 ± 1004 1 | 9.22 ± 2.24 1 |
| K002 | | 8.79 ± 2.03 2 | 5.26 ± 1.58 3 | 9630 ± 2502 2 | 6.00 ± 0.62 2 |
| B006 | | 11.35 ± 0.83 1 | 8.11 ± 0.55 1 | 11284 ± 695 1 | 8.31 ± 1.50 1 |
| PVA COM | | 12.59 ± 1.69 1 | 7.34 ± 0.65 2 | 10757 ± 877 1 | 5.12 ± 1.40 2 |

* Lowercase letters and numbers (a, b and c; 1, 2 and 3) in the same column represent comparisons between formulation of the composites at 10 d and 100 cycles, respectively.

TABLE 3.2

| | Suction and | WA | BD | AP |
|---|---|---|---|---|
| Formulations | pressing | (%) | (g/cm³) | (%) |
| PP COM | 10 | 19.44 ± 1.55 a | 1.59 ± 0.05 a | 30.24 ± 1.54 b |
| K001 | days | 20.65 ± 1.97 a | 1.56 ± 0.05 a | 32.18 ± 1.30 a, b |
| K002 | | 20.72 ± 1.36 a | 1.56 ± 0.05 a | 32.23 ± 1.17 a |
| B006 | | 19.37 ± 1.79 a | 1.59 ± 0.07 a | 30.75 ± 1.64 a, b |
| PVA COM | | 19.86 ± 0.77 a | 1.58 ± 0.03 a | 31.33 ± 0.81 a, b |
| PP COM | 100 | 19.02 ± 0.63 1 | 1.59 ± 0.03 1 | 30.22 ± 0.50 2 |
| K001 | cycles | 20.32 ± 0.05 1 | 1.57 ± 0.05 1 | 31.76 ± 1.01 1 |
| K002 | | 19.72 ± 1.57 1 | 1.59 ± 0.06 1 | 31.18 ± 1.23 1 |
| B006 | | 19.65 ± 1.48 1 | 1.60 ± 0.06 1 | 31.42 ± 1.21 1 |
| PVA COM | | 19.39 ± 0.89 1 | 1.58 ± 0.05 1 | 30.68 ± 1.15 1 |

* Lowercase letters and numbers (a, b and c; 1, 2 and 3) in the same column represent comparisons between formulation of the composites at 10 d and 100 cycles, respectively.

In Tables 3.1 and 3.2, different letters and numbers indicate significant differences amongst the properties of the composites.

FIG. 1C illustrates the results of the limit of proportionality (LOP), which infers the performance and behavior of the fiber in the matrix. The results show no significant difference between the formulations at 10d. After 100 C, composites with PP COM and K1 showed better results. This behavior of PP COM and K1 possibly presents an improvement in the adhesion between fiber and matrix in relation to other formulations. Flat pads produced by the Hatschek process showed no difference in LOP and modulus of proportionality (MOE) both for 10d and after 100 C.

The MOE values indicate the stiffness of the specimens. The MOE values of cementitious composites reinforced with PP and PVA showed no significant difference between the formulations, both for 10d and 100 C. After 100 C, there was a small increase in MOE values, demonstrating that PP and PVA fibers are effective for increasing the stiffness of the specimens (Zhang et al., 2022).

Table 4.1—Average values and standard deviations of modulus rupture (MOR), Limit of proportionality (LOP), modulus of elasticity (MOE), specific energy (SE), water absorption (WA), bulk density (BD) and apparent porosity (AP) of the flat pads reinforced with polypropylene fiber (PP COM, K1, K2, B6) and polyvinyl alcohol fiber (PVA) produced by Hatschek process in the conditions at 10 days (10d) of curing and after 100 accelerated aging cycles (100 C)*.

| | | MOR | LOP | MOE | SE |
|---|---|---|---|---|---|
| Formulations | Hatschek | (MPa) | (MPa) | (MPa) | (kJ/m²) |
| PP COM | 10 | 7.60 ± 0.48 b | 3.97 ± 0.66 a | 6513 ± 753 a | 6.70 ± 0.92 c |
| K001 | days | 9.44 ± 0.50 a, b | 4.19 ± 0.66 a | 6985 ± 521 a | 10.18 ± 0.49 a |
| K002 | | 9.66 ± 0.19 a | 4.20 ± 0.19 a | 6733 ± 439 a | 10.30 ± 0.22 a |
| B006 | | 8.98 ± 0.65 b | 3.84 ± 0.63 a | 6622 ± 625 a | 8.36 ± 1.17 b |
| PP COM | 100 | 10.02 ± 0.61 3 | 5.37 ± 0.34 1 | 9381 ± 1134 1 | 8.95 ± 0.64 3 |
| K001 | cycles | 13.58 ± 0.59 1 | 5.93 ± 0.84 1 | 9263 ± 863 1 | 13.35 ± 0.55 1 |
| K002 | | 12.80 ± 0.42 2 | 5.65 ± 0.71 1 | 8998 ± 1122 1 | 13.58 ± 0.35 1 |
| B006 | | 12.36 ± 0.16 2 | 5.39 ± 0.28 1 | 8531 ± 678 1 | 12.39 ± 0.93 2 |

* Lowercase letters and numbers (a, b and c; 1, 2 and 3) in the same column represent comparisons between formulation of the flat pads at 10 d and 100 cycles, respectively.
Different letters and numbers indicate significant differences amongst the properties of the composites.

TABLE 4.2

| | | WA | BD | AP |
|---|---|---|---|---|
| Formulations | Hatschek | (%) | (g/cm³) | (%) |
| PP COM | 10 | 31.82 ± 1.13 a | 1.36 ± 0.03 a, b | 43.10 ± 0.75 a |
| K001 | days | 30.39 ± 0.40 b | 1.38 ± 0.01 a | 41.83 ± 0.25 b, c |
| K002 | | 31.42 ± 0.83 a, b | 1.35 ± 0.02 b | 42.38 ± 0.58 a, b |
| B006 | | 31.16 ± 0.92 a, b | 1.36 ± 0.02 a, b | 42.29 ± 0.64 b, c |
| PP COM | 100 | 28.49 ± 0.97 1 | 1.42 ± 0.02 1 | 40.50 ± 0.70 1 |
| K001 | cycles | 28.11 ± 0.44 1 | 1.42 ± 0.01 1 | 39.44 ± 0.33 2 |
| K002 | | 28.90 ± 0.66 1 | 1.41 ± 0.01 1 | 40.60 ± 0.51 2 |
| B006 | | 28.41 ± 0.66 1 | 1.42 ± 0.02 1 | 40.23 ± 0.49 1, 2 |

* Lowercase letters and numbers (a, b and c; 1, 2 and 3) in the same column represent comparisons between formulation of the flat pads at 10 d and 100 cycles, respectively.
Different letters and numbers indicate significant differences amongst the properties of the composites.

Cementitious composites and flat pads reinforced with K1 show higher specific energy (SE) results at 10d and after 100 C. The fact that the fibers present similar surface area indicates that the K1 fiber showed better interaction with the cement matrix, increasing the slip capacity during bending and, thus, increasing the energy absorption, as observed by the specific energy value. However, after 100 C, there was a tendency to increase for all fibers, due to cement rehydration, but not showing the same behavior as K1 fiber. The toughening of the cement matrix is related to several phenomena that occur during its fracture, such as: debonding of the matrix, pulling-out, bridging and, finally, the breaking (fracturing) of the fibers (Almeida et al., 2013). Fiber pull-out is the main responsible for the toughening mechanism and energy absorption by the composite. This strong bond between fiber and matrix can be seen in the fracture surface image of the composite reinforced with K1 fiber (FIG. 3A) which showed a good adhesion compared to the PVA fiber (FIG. 3B) which reflected the SE results after 100 C.

In general, the physical results did not show significant differences in water absorption (AA) and apparent density (PA) in cementitious composites. However, there was a small decrease in the porosity of the composites reinforced with PP COM at 10 days and after 100 C, on the other hand, they did not differ in relation to the other formulations. Flat pads reinforced with PP COM showed higher water absorption and porosity between the reinforcing fibers at 10d. This behavior may possibly be related to the aspect ratio (see Table 1) of the fibers, the distribution of fibers in the matrix and, also the influence of the production process that induces the difficulty of packaging the composite and, thus, contributes to the greater absorption and porosity. Another factor is a lower adhesion between matrix fiber, which induces a predominance of fiber pullout with a lower SE value. This characteristic can be a negative aspect, generating defects in the microstructure of the composites.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures.

What is claimed:

1. A polypropylene fiber comprising:
a polypropylene matrix,
at least a surface modifier,
at least an additive selected from surfactants, lubricating agents or mixtures thereof.

2. The polypropylene fiber according to claim 1, wherein the polypropylene matrix is a homopolymer.

3. The polypropylene fiber according to claim 1, wherein the polypropylene matrix comprises at least a comonomer selected from ethylene and C4 to C8 alpha olefins, wherein a percentage of the comonomer percentage by weight (wt. %) based on the weight of polypropylene ranges from 0.5 to 10 wt %.

4. The polypropylene fiber according to claim 1, wherein the polypropylene matrix is a heterophasic polypropylene comprising a rubber phase dispersed in a polypropylene continuous phase, wherein the rubber phase comprises propylene and at least a comonomer selected from ethylene, C4 to C8 alpha-olefins, where the comonomer is present at a percent by weight (wt. %) of the rubber phase that ranges from 5 to 75 wt %.

5. The polypropylene fiber according to claim 4, wherein the rubber phase is present at a percent by weight (wt. %) that ranges from 2 to 75 wt. %, based on the heterophasic polypropylene.

6. The polypropylene fiber according to claim 1, wherein the polypropylene matrix has Melt Flow Rate (230° C./2.16 kg) as determined according to ASTM D1238, that ranges from 10 g/10 min to 20 g/10 min.

7. The polypropylene fiber according to claim 1, wherein the surface modifier is selected from organic surface modifiers, inorganic surface modifiers and mixtures thereof.

8. The polypropylene fiber according to claim 1, wherein the surface modifier is selected from talc, calcium carbonate, calcium hydroxide, mica, calcium silicate, clay, kaolin, alumina, silica, wollastonite, magnesium carbonate, magnesium hydroxide, zinc oxide, titanium oxide, barium sulfate, zinc sulfate and combinations thereof.

9. The polypropylene fiber according to claim 1, wherein the surface modifier is coated or has a surface treatment.

10. The polypropylene fiber according to claim 9, wherein the surface modifier is coated calcium carbonate.

11. The polypropylene fiber according to claim 1, wherein the surface modifier is present in a percentage by weight (wt. %) that ranges 0.3 wt. % to 20 wt. %, based on the polypropylene fiber weight.

12. The polypropylene fiber according to claim 1, wherein the surfactant is selected from ionic, non-ionic and amphoteric surfactants or combinations thereof.

13. The polypropylene fiber according to any claim 1, wherein the surfactant is selected from sulfates, sulfonates, phosphate esters, carboxylates, amines, quaternary ammonium, alcohols, acids, ethoxylates, and combinations thereof.

14. The polypropylene fiber according to claim 13, wherein the surfactant is a fatty alcohol comprising ethylene oxide and/or propylene oxide.

15. The polypropylene fiber according to claim 1, wherein the amount of surfactant in the fiber ranges from 0.3 wt. %, to 7 wt %, based on the polypropylene fiber weight.

16. The polypropylene fiber according to claim 1, wherein the surface modifier and, optionally, the surfactant, are incorporated in the polypropylene matrix by extrusion.

17. The polypropylene fiber according to claim 1, wherein the lubricating agent is applied to the fibers during a spinning process.

18. The polypropylene fiber according to claim 1, wherein the fiber presents a rheological polydispersity index that ranges from 1.75 to 3.

19. The polypropylene fiber according to claim 1, wherein the fiber presents a Mw/Mn that ranges from 2 to 5.5.

20. The polypropylene fiber according to claim 1, wherein the fiber presents a tenacity that ranges from 7 to 15 cN/dtex.

21. The polypropylene fiber according to claim 1, wherein the fiber presents an elongation that ranges from 5 to 18%.

22. A method of producing polypropylene fibers according to claim 1, comprising the steps of:
(i) mixing a polypropylene with a surface modifier in extrusion, and
(ii) melt spinning the composition obtained in step (i) to produce the fibers,
wherein a surfactant is added to step (i) and/or a lubricant is applied to the fibers during step (ii).

23. The method according to claim 22, wherein the fibers are further cut into filaments having from 5 to 20 mm length.

24. A fiber cement-reinforced composite comprising:
a cementitious matrix; and
a polypropylene fiber comprising:
a polypropylene matrix,
at least a surface modifier,
at least one additive selected from surfactants, lubricating agents and mixtures thereof;
a cellulosic component; and
optionally a limestone component.

25. The composite according to claim 24, comprising the fibers according to claim 1.

26. The composite, according to claim 24, wherein the polypropylene fibers length ranges from 7 to 14 mm.

27. The composite according to claim 24 wherein the polypropylene fibers are present in a percentage by weight (wt. %) that ranges from 0.3 to 5 wt % based on the total weight of the cement composite.

28. An article comprising the fiber cement-reinforced composite according to claim 24.

29. A roof tile comprising the fiber cement-reinforced composite according to claim 24.
